(19) United States
(12) Patent Application Publication
(10) Pub. No.: US 2025/0191023 A1
(43) Pub. Date: Jun. 12, 2025

(54) SYSTEMS AND METHODS FOR MARKETING REACTION SIMULATION

(71) Applicant: KLICK INC., Toronto (CA)

(72) Inventors: Jason Anthony MIFSUD, Toronto (CA); Alfred Jay WHITEHEAD, Toronto (CA)

(21) Appl. No.: 18/975,596

(22) Filed: Dec. 10, 2024

Related U.S. Application Data
(60) Provisional application No. 63/609,054, filed on Dec. 12, 2023.

(51) Int. Cl. G06Q 30/0242; G06Q 30/0204; G06Q 30/0251

(52) U.S. Cl. CPC G06Q 30/0242; G06Q 30/0205; G06Q 30/0269

(57) ABSTRACT

Provided are computer-implemented systems and methods for simulating a reaction to a marketing message. A marketing message request including one or more marketing messages is received. A simulation profile is generated based on the marketing request and a plurality of healthcare professional profiles. A simulated reaction to the one or more marketing message is generated for a candidate healthcare professional profile of the plurality of healthcare professional profiles by sensing a first prompt including the candidate profile and the marketing message to an LLM system and receiving a first response based on the first prompt. The first response can include the simulated reaction from the candidate healthcare professional profile. The simulation profile is updated with the simulated reaction and the reaction is output.

### CROSS-REFERENCE TO RELATED APPLICATION

This application claims the benefit of U.S. Provisional Application No. 63/609,054 filed on Dec. 12, 2023, which is incorporated by reference herein in its entirety.

### FIELD

The present disclosure is directed to systems and methods for simulating human responses to targeted messaging, and more specifically, to systems and methods for simulating responses of healthcare professionals using a Large Language Model.

### BACKGROUND

Large language models (LLMs) can be immensely powerful tools for performing predictive simulations. However, there are many challenges in ensuring that these tools are used effectively and generate usable and reliable results. These challenges include the inherent biases in the training of the LLM model and the often poor statistical distribution of responses from LLMs.

Pharmaceutical companies have challenges in the pre-market phase of drug-development when marketing strategies are devised. It can be a particular challenge to ensure that healthcare professionals (HCPs) receive relevant information about new drugs and their benefits and are aware of innovative new therapies that are available. Assessing the effectiveness of marketing messages typically involves traditional market research, qualitative studies, data analysis, and machine learning models. These conventional solutions have difficulty predicting the impact of marketing messages and channels on a wide variety of target recipients.

Conventional solutions also tend to be inefficient and time-consuming. Existing solutions often require testing marketing messages on test groups, evaluating their feedback, and extrapolating the success or failure of the message on the test groups to the broader population. These iterations can take a long time, and the relative cost of evaluating the marketing messages means that fewer candidate messages can be tested. This also limits the variety of the target recipients to those willing and able to participate in a test group, which is not always reflective of the underlying target population.

### SUMMARY

The following summary is intended to introduce the reader to various aspects of the detailed description, but not to define or delimit any invention.

The present disclosure relates to systems and methods for constructing and executing simulations to assess the effectiveness of marketing messages. In particular, the present disclosure enables the implementation of marketing reaction simulations that simulate the reaction of a set of target individuals to one or more marketing message(s). The marketing reaction simulations can be used to predict the impact of marketing messages on target individuals by simulating interactions between those target individuals and marketing messages. The systems and methods described herein can also provide for simulated target profiles to be generated, thereby enabling the marketing reaction simulations to reflect a broader spectrum of target individuals through simulated profiles. The systems and methods described herein may help shorten the marketing message design cycle and efficiently model the behavior of marketing strategies in the pre-market phase, allowing for multiple revisions and enhancing the effectiveness of marketing messages before actual deployment.

The systems and methods of the present disclosure are defined to ensure more accurate simulation results. In particular, the systems and methods of the present disclosure can be used to generate unique profiles for target individuals that can be used by the LLM, along with predefined messages or message-channel combinations, to generate simulated reactions. The simulated reactions generated by the target individual profiles can then be used to assess and refine the tested message(s). The disclosed systems and methods can be provided as a user-friendly tool that enables a user to generate unique profile parameters and relevant prompts that can be provided to the LLM to enable the LLM to simulate the desired interactions. This may include several prompts provided in a chain, or conversational format, to generate accurate predictions of marketing impact. The systems and methods described herein can be employed to constrain the use of an LLM to ensure that predictions and simulations accurately reflect the behavior being modelled or predicted.

In an aspect of this disclosure, there is provided a computer-implemented method for evaluating the effectiveness of a marketing message by simulating a reaction to the marketing message, comprising: receiving, by a processor, a marketing message request comprising one or more marketing messages; generating, by the processor, a simulation profile based on a plurality of healthcare professional profiles and the marketing message request; generating, at the processor, a simulated reaction to the one or more marketing messages for a candidate healthcare professional profile of the plurality of healthcare professional profiles in the simulation profile, the simulated reaction generated by: sending, to a large language model system, a first prompt comprising the candidate healthcare professional profile and the one or more marketing messages; and receiving, from the large language model system, a first response based on the first prompt comprising the simulated reaction to the one or more marketing messages from the candidate healthcare professional profile, updating the simulation profile with the simulated reaction; and outputting, at a display device in communication with the processor, the reaction to the marketing message based on the simulation profile.

The method can include generating, at the processor, a data frame, and storing the data frame in the simulation profile.

The plurality of healthcare professional profiles can include a plurality of simulated healthcare professional profiles, where each simulated healthcare professional profile is generated by a large language model in response to a profile generation prompt that specifies target profile characteristics, where the target profile characteristics comprise a plurality of profile parameters and a plurality of parameter distribution sets, where each parameter distribution set corresponds to a particular profile parameter in the plurality of profile parameters and each parameter distribution set defines a statistical distribution of parameter values that can be defined for the corresponding profile parameter for the simulated healthcare professional profiles.

The method can include generating the plurality of simulated healthcare professional profiles by transmitting the profile generation prompt to the large language model and receiving the plurality of simulated healthcare professional profiles as an output from the large language model.

The method can include validating the simulated healthcare professional profiles in the plurality of simulated healthcare professional profiles by automatically comparing the profile parameters of each simulated healthcare professional profile received from the large language model to the plurality of parameter distribution sets.

The method can include identifying at least one invalid simulated healthcare professional profile and omitting each simulated healthcare professional profile in the at least one invalid simulated healthcare professional profile from the plurality of healthcare professional profiles included in the simulation profile.

The method can include generating, at the processor, a simulated reaction set for each marketing message by for each healthcare professional profile in the plurality of simulated healthcare professional profiles, generating a simulated reaction to that marketing message.

The method can include generating a visualization output for a given marketing message by, for that given marketing message, generating a visual representation of the simulated reaction set; and displaying the visualization output on a display device.

The method can include validating the simulated reaction set using a predefined validation script.

Generating the simulation profile can include: sending, to the large language model system, at least one existing component of the candidate healthcare professional profile; receiving, from the large language model system, a simulated component of the candidate healthcare professional profile; and updating the candidate healthcare professional profile with the simulated component prior to generating the simulated reaction for the candidate healthcare professional profile.

The simulated reaction can include a reaction indictor corresponding to one of a simulated ignore, an unchanged reaction, or a convinced reaction.

The simulated reaction can include a simulated rationale associated with the simulated reaction, where the simulated rationale provides a qualitative description generated by the large language model of a rationale for the simulated reaction generated by the candidate healthcare professional profile.

In another aspect of this disclosure, there is provided a computer-implemented system for evaluating the effectiveness of a marketing message by simulating a reaction to the marketing message, the system comprising: a non-transitory storage memory storing a plurality of healthcare professional profiles, comprising: a processor in communication with the memory, the processor configured to: receive, a marketing message request comprising one or more marketing messages; generate a simulation profile based on the plurality of healthcare professional profiles and the marketing message request; generate a simulated reaction to the one or more marketing messages for a candidate healthcare professional profile of the plurality of healthcare professional profiles in the simulation profile, the simulated reaction generated by: sending, to a large language model system, a first prompt comprising the candidate healthcare professional profile and the one or more marketing messages; and receiving, from the large language model system, a first response based on the first prompt comprising the simulated reaction to the one or more marketing messages from the candidate healthcare professional profile, update the simulation profile with the simulated reaction; and output, to a display device in communication with the processor, the reaction to the marketing message based on the simulation profile.

The processor can be further configured to generate a data frame, and store the data frame in the simulation profile.

The plurality of healthcare professional profiles can include a plurality of simulated healthcare professional profiles, where each simulated healthcare professional profile is generated by a large language model in response to a profile generation prompt that specifies target profile characteristics, where the target profile characteristics comprise a plurality of profile parameters and a plurality of parameter distribution sets, where each parameter distribution set corresponds to a particular profile parameter in the plurality of profile parameters and each parameter distribution set defines a statistical distribution of parameter values that can be defined for the corresponding profile parameter for the simulated healthcare professional profiles.

The processor can be further configured to generate the plurality of simulated healthcare professional profiles by transmitting the profile generation prompt to the large language model and receiving the plurality of simulated healthcare professional profiles as an output from the large language model.

The processor can be further configured to validate the simulated healthcare professional profiles in the plurality of simulated healthcare professional profiles by automatically comparing the profile parameters of each simulated healthcare professional profile received from the large language model to the plurality of parameter distribution sets.

The processor can be further configured to identify at least one invalid simulated healthcare professional profile and omit each simulated healthcare professional profile in the at least one invalid simulated healthcare professional profile from the plurality of healthcare professional profiles included in the simulation profile.

The processor can be further configured to: generate a simulated reaction set for each marketing message by for each healthcare professional profile in the plurality of simulated healthcare professional profiles, generating a simulated reaction to that marketing message.

The processor can be further configured to: generate a visualization output for a given marketing message by, for that given marketing message, generating a visual representation of the simulated reaction set; and display the visualization output on the display device.

The processor can be further configured to validate the simulated reaction set using a predefined validation script.

The processor can be configured to generate the simulation profile by: sending to the large language model system, the candidate healthcare professional profile; receiving from the large language model system a simulated component of the candidate healthcare professional profile; and updating the candidate healthcare professional profile with the simulated component.

The simulated reaction can include one of a simulated ignore, an unchanged reaction, or a convinced reaction.

The simulated reaction can include a simulated rationale associated with the simulated reaction.

In an aspect of the disclosure, there is provided a computer-implemented method for simulating a reaction to a marketing message, comprising: providing, at a memory, a healthcare profile database comprising a plurality of healthcare professional profiles; receiving, at a network device, a marketing message request comprising a marketing message; generating, at a processor in communication with the memory, a simulation profile based on the plurality of healthcare professional profiles, a plurality of patient profiles, and the marketing message request, each simulation profile comprising an event sequence, the event sequence comprising one or more marketing message events and one or more patient interaction events; generating, at the processor, a simulated reaction to the one or more marketing message events for a candidate healthcare professional profile in the simulation profile, the simulated reaction determined by: sending, to a large language model system, a first prompt comprising the candidate healthcare professional profile and the one or more marketing message events; and receiving, from the large language model system, a first response based on the first prompt comprising the simulated reaction to the one or more marketing message events from the candidate healthcare professional profile, updating the simulation profile with the simulated reaction; and outputting, at a display device in communication with the processor, the reaction to the marketing message based on the simulation profile.

The order of the event sequence including marketing message events and patient interaction events may be variable and optionally randomized in the simulation.

The method may further include: generating, at the processor, a data frame, and storing the data frame in the simulation profile.

The method may further include providing, at the memory, a patient profile database comprising the plurality of patient profiles; generating, at the processor, a simulated patient interaction between the candidate healthcare professional profile and a candidate patient profile, the simulated patient interaction determined by: sending, to the large language model system, a second prompt comprising the candidate healthcare professional profile and the candidate patient profile; and receiving, from the large language model system, a second response comprising the simulated patient interaction; wherein the simulated reaction comprises the simulated patient interaction.

The simulated patient interaction can include at least one medication treatment recommendation.

The method may further include: providing, at the memory, a drug distribution database; where generating the simulation profile includes generating a simulated prescription behavior of each of the plurality of healthcare professional profiles for one or more medications in the drug distribution database.

The simulated prescription behavior may include one or more medications generated by the large language model system.

Generating the simulation profile may include: sending, to the large language model system, the candidate healthcare professional profile; receiving, from the large language model system, a simulated component of the candidate healthcare professional profile; and updating the candidate healthcare professional profile with the simulated component.

Generating the simulation profile may include: sending, to the large language model system, the candidate patient profile; receiving, from the large language model system, a simulated component of the candidate patient professional profile; and updating the candidate patient profile with the simulated component.

The method may further include: providing, at the memory, a simulation profile database; and generating the simulation profile can include storing the simulation profile in the simulation profile database.

The method may further include: normalizing the one or more predicted prescriptions of the simulation profile.

The simulated reaction may include one of a simulated ignore, an unchanged reaction, or a convinced reaction.

The simulated reaction may include a simulated rationale associated with the simulated reaction.

In an aspect of this disclosure, there is provided a computer-implemented system for marketing reaction simulation, comprising: a memory, comprising: a healthcare profile database comprising a plurality of healthcare professional profiles; a network device for receiving a marketing message request comprising a marketing message; a processor in communication with the memory and the network device, the processor configured to: generate a simulation profile based on the plurality of healthcare professional profiles, a plurality of patient profiles, and the marketing message request, each simulation profile comprising an event sequence, the event sequence comprising one or more marketing message events and one or more patient interaction events; generate a simulated reaction to the one or more marketing message events for a candidate healthcare professional profile in the simulation profile, the simulated reaction determined by: sending using the network device, to a large language model system, a first prompt comprising the candidate healthcare professional profile and the one or more marketing message events; and receiving using the network device, from the large language model system, a first response based on the first prompt comprising the simulated reaction to the one or more marketing message events from the candidate healthcare professional profile, update the simulation profile with the simulated reaction; and outputting, to a display device in communication with the processor, the reaction to the marketing message based on the simulation profile.

The order of the event sequence including marketing message events and patient interaction events may be variable and optionally randomized in the simulation.

The processor may be further configured to generate a data frame, and store the data frame in the simulation profile.

The memory may include a patient profile database that can include the plurality of patient profiles; the processor may be further configured to: generate a simulated patient interaction between the candidate healthcare professional profile and a candidate patient profile, the simulated patient interaction determined by: sending, using the network device, to the large language model system, a second prompt including the candidate healthcare professional profile and the candidate patient profile; and receiving, using the network device, from the large language model system, a second response comprising the simulated patient interaction; where the simulated reaction may include the simulated patient interaction.

The simulated patient interaction may include at least one medication treatment recommendation.

The memory may include a drug distribution database; the processor may be further configured to generate the simulation profile by: generating a simulated prescription behavior of each of the plurality of healthcare professional profiles for one or more medications in the drug distribution database.

The simulated prescription behavior may comprise one or more medications generated by the large language model system.

Generating the simulation profile may include: sending, using the network device, to the large language model system, the candidate healthcare professional profile; receiving, using the network device, from the large language model system, a simulated component of the candidate healthcare professional profile; and updating the candidate healthcare professional profile with the simulated component.

Generating the simulation profile may comprise: sending, using the network device, to the large language model system, the candidate patient profile; receiving, using the network device, from the large language model system, a simulated component of the candidate patient professional profile; and updating the candidate patient profile with the simulated component.

The memory may include a simulation profile database; and generating the simulation profile may include storing the simulation profile in the simulation profile database.

The processor may be further configured to: normalize the one or more predicted prescriptions of the simulation profile.

The simulated reaction may include one of a simulated ignore, an unchanged reaction, or a convinced reaction.

The simulated reaction may include a simulated rationale associated with the simulated reaction.

It will be appreciated by a person skilled in the art that an apparatus, computer program product, system, or method disclosed herein may embody any one or more of the features contained herein and that the features may be used in any particular combination or sub-combination.

These and other aspects and features of various examples will be described in greater detail below.

### DRAWINGS

The drawings included herewith are for illustrating various examples of articles, methods, and apparatuses of the present specification and are not intended to limit the scope of what is taught in any way. In the drawings:

FIG. 1 shows a system diagram of an example marketing reaction system.

FIG. 2 shows a block diagram of an example device that may be used in the marketing reaction system of FIG. 1.

FIG. 3 shows an example user interface that may be provided in conjunction with the marketing reaction system of FIG. 1.

FIG. 4A shows a flowchart of an example method of simulating a marketing reaction.

FIG. 4B shows a flowchart of an example method of generating a simulated reaction to a marketing message.

FIG. 5 shows a flowchart of another example method of simulating a marketing reaction.

FIG. 6 shows a block diagram of an example data flow for an example method of simulating a marketing reaction.

### DETAILED DESCRIPTION

Various apparatuses or methods will be described below to provide an example of the claimed subject matter. No example described below limits any claimed subject matter and any claimed subject matter may cover methods or apparatuses that differ from those described below. The claimed subject matter is not limited to apparatuses or methods having all of the features of any one apparatus or methods described below or to features common to multiple or all of the apparatuses or methods described below. It is possible that an apparatus or methods described below is not an example that is recited in any claimed subject matter. Any subject matter disclosed in an apparatus or methods described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It should also be noted that the terms “coupled” or “coupling” as used herein can have several different meanings depending on the context in which these terms are used. For example, the terms “coupled”, or “coupling” can have a mechanical, electrical or communicative connotation. For example, as used herein, the terms “coupled”, or “coupling” can indicate that two elements or devices can be directly connected to one another or connected to one another through one or more intermediate elements or devices via an electrical element, electrical signal or a mechanical element depending on the particular context. Furthermore, the term “communicative coupling” indicates that an element or device can electrically, optically, or wirelessly send data to another element or device as well as receive data from another element or device.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Some elements herein may be identified by a part number, which is composed of a base number followed by an alphabetical or subscript-numerical suffix (e.g., 112a, or 112₁). Multiple elements herein may be identified by part numbers that share a base number in common and that differ by their suffixes (e.g., 112₁, 112₂, and 112₃). All elements with a common base number may be referred to collectively or generically using the base number without a suffix (e.g., 112).

The example systems and methods described herein may be implemented in hardware or software, or a combination of both. In some cases, the examples described herein may be implemented, at least in part, by using one or more computer programs, executing on one or more programmable devices comprising at least one processing element, a data storage element (including volatile and non-volatile memory and/or storage elements), and at least one communication interface. These devices may also have at least one input device (e.g., a keyboard, a mouse, a touchscreen, and the like), and at least one output device (e.g., a display screen, a printer, a wireless radio, and the like) depending on the nature of the device. For example, and without limitation, the programmable devices (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some examples, the communication interface may be a network communication interface. In examples in which elements are combined, the communication interface may be a software communication interface, such as those for inter-process communication (IPC). In still other examples, there may be a combination of communication interfaces implemented as hardware, software, and a combination thereof.

Program code may be applied to input data to perform the functions described herein and to generate output information. The output information is applied to one or more output devices, in known fashion.

Each program may be implemented in a high-level procedural, declarative, functional or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Examples of the system may also be considered to be implemented as a non-transitory computer-readable storage medium, configured with a computer program, where the storage medium so configured causes a computer to operate in a specific and predefined manner to perform the functions described herein.

Furthermore, the example system, processes and methods are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

Various examples of systems, methods and computer programs products are described herein. Modifications and variations may be made to these examples without departing from the scope of the invention, which is limited only by the appended claims. Also, in the various user interfaces illustrated in the figures, it will be understood that the illustrated user interface text and controls are provided as examples only and are not meant to be limiting. Other suitable user interface elements may be used with alternative implementations of the systems and methods described herein.

The present disclosure provides improvements to existing computer-based simulation systems, and existing LLM-based generative systems—all of which require computers. One particular example of an LLM-based generative system that may be improved is the GPT-4 model created by OpenAI. The present disclosure provides systems and methods that enable reactions to messages and complex HCP-patient interactions to be effectively simulated using an LLM in order to predict the impact of marketing messages on target individuals. The systems and methods described herein facilitate and enable efficient and accurate pre-market refinement and optimization of messages through multiple iterations.

The systems and methods described herein can use large language models such as GPT-4 to simulate interactions between HCPs, patients, and potential marketing messages, instead of employing the resultant data to generate simulations. The integration of real-world data (including HCP data, drug distribution data, etc.) contributes to the accuracy of the created profiles and overall effectiveness of the simulation.

Implementing simulations using large language models often present challenges. These challenges include the inherent biases in the training of the LLM model and the poor statistical distribution of responses from LLMs. Accordingly, the systems and methods described herein provide for constrained use of an LLM system to ensure the simulations are representative of the quantitative behavior of the target individuals being modeled.

The present disclosure can be implemented to improve cost-effectiveness in the creation of marketing message. The ability to conduct simulations on a large number of marketing messages in an efficient and accurate manner results in improved performance data that can be used to identify more potentially successful options when compared with conventional methods. This can assist users in developing a marketing strategy through the integration of LLM-driven simulations and real-world data.

In the systems and methods described herein, limited aspects of real data from existing target individuals (e.g. name, location, and specialty) can be used to generate profiles for a simulation. A generative model (e.g. an LLM) can be used to generate and simulate additional characteristics for target individual profiles and/or generate artificial target individual profiles. These augmented or artificial profiles can then be used to simulate interactions with and reactions to marketing messages within a simulation implemented by a large language model, guided by detailed prompts.

In some examples, patient profiles can also be generated and/or augmented based at least in part on real-life census data for patient age and gender, as well as drug distribution data. The randomness in the selection of message-channel combinations and the incorporation of the inherent randomness of the LLM in generating outputs are addressed within the simulation.

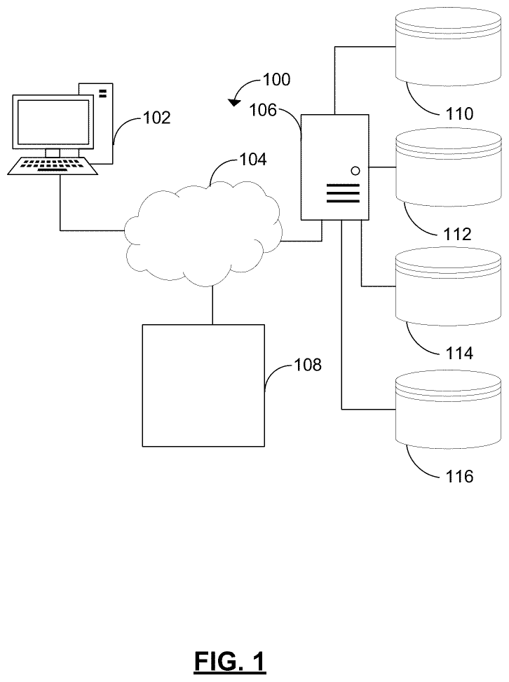

Referring first to FIG. 1, there is shown a block diagram of a marketing reaction simulation system 100. The marketing reaction simulation system 100 may incorporate aspects of real HCP data (such as name, location, and specialty) and census data for patient age and gender. An LLM may be used to simulate interactions and to generate and simulate additional components for HCP and patient profiles, as well as the interactions within the simulation, guided by detailed prompts. The incorporation of real HCP data, as well as specific statistical information, can improve the operation of the LLM and address the randomness in the selection of message-channel combinations and the incorporation of the LLMs inherent randomness in generating outputs. This facilitates the simulation of complex HCP-patient interactions using an LLM and predicting the impact of marketing messages on prescription behavior.

In the example illustrated, marketing reaction simulation system 100 includes one or more user devices 102, a network 104, one or more servers 106, an HCP profile database 110, a patient profile database 112, a drug distribution database 114, a simulation profile database 116 and one or more LLM systems 108.

Each user device 102 may be used by a user such as a subject, administrator, clinician, or other medical professional to interact with system 100 in order to perform operations relating to simulating a marketing reaction.

Each user device 102 may be any two-way communication device with capabilities to communicate with other devices. The user device 102 can generally be in communication with (or able to establish communication with) server 106. The user device 102 may send and receive requests to the server 106 using different types of communication channels including text, email, phone call, Voice-over-Internet-Protocol (VOIP), web application, chat application, social media message, etc.

As will be understood, a user device 102 may be any suitable computing device capable of executing an application. User device 102 generally refers to a computing device such as desktop or laptop computers, smartphones, tablet computers, as well as a wide variety of “smart” devices capable of data communication. User devices 102 each include a processor, a volatile and non-volatile memory, at least one network interface, and input/output devices. User devices 102 may be portable, and may at times be connected to network 110 or a portion thereof. The user devices 102 may be a mobile devices such as mobile devices running the Google® Android® operating system or Apple® iOS® operating system.

Each of the user devices 102 can have a plurality of software applications operating thereon. The plurality of software applications can include a user simulation application that can be used by the user of user device 102 in order to provide inputs to a process of simulating a marketing reaction.

The user may access the user simulation application, for example, to submit marketing reaction requests that include one or more candidate marketing messages. Users may also submit data, such as healthcare provider data for the HCP profile database 110, patient data for the patient profile database 112, drug distribution data for the drug distribution database 114 etc. The user may further use the user simulation application to review the output of marketing reactions that are stored in the simulation profile database 116.

The user device 102 may be operated by a user to access a web-based user simulation software application (not shown) running on server 106 over network 104. Optionally, a user device 102 may access a web application hosted at server 106 using a browser application operating on the user device 102.

Alternatively or in addition, the user simulation application may be a standalone program (or software application) that is downloaded and installed on the user device 102. A user device 102 may download an application (including downloading from an App Store such as the Apple® App Store or the Google® Play Store) for interacting with the marketing reaction simulation system.

A user device 102 may be the personal device of a user or may be a device provided by an employer. The user device 102 may be in communication with server 106 and may allow a user to review a marketing reaction simulation result.

The user simulation application accessible to the user either via an application at user device 102 or via a web interface from server 106 may include a chatbot interface. The user simulation application may allow the user to upload data and/or documents that include one or more marketing messages. The marketing messages can be predefined by the user as one or more candidate marketing messages to be tested.

A marketing message can be provided in a variety of message formats. The message formats can include a textual message format, a static image message format, a video message format, an audio message format, and/or a combined format message that includes elements from two or more of the textual message format, static image message format, video message format, and audio message format. The marketing messages can be input to the user simulation application, for instance as a one-dimensional message array that includes a cell for each candidate marketing message.

A user may also input one or more message-channel combinations for the one or more marketing messages. Each message-channel combination can specify a combination of a particular marketing message and a particular marketing message channel to be simulated. The marketing messages can be input to the user simulation application, for instance as a two-dimensional message array that includes a row (or alternatively column) for each candidate marketing message and a column (or alternatively row) for each marketing channel to be tested. In this case, each cell of the two-dimensional message array can correspond to a message-channel combination to be simulated.

The software application running on the one or more user devices 102 may communicate with server 106 using an Application Programming Interface (API) endpoint. The user simulation application can be used to send marketing simulation requests, marketing simulation responses, and other requests in order to administer the marketing simulations.

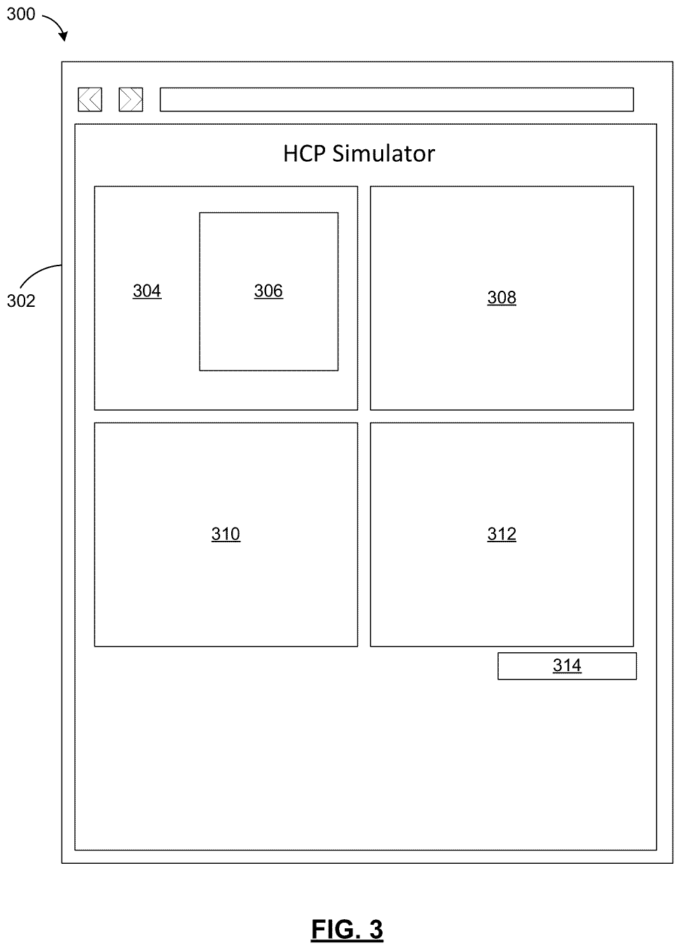

The software application running on the one or more user devices 102 may display one or more user interfaces on a display device of the user device, including, but not limited to, the example user interfaces shown in FIG. 3.

Network 104 may be any network or network components capable of carrying data including the Internet, Ethernet, fiber optics, satellite, mobile, wireless (e.g. Wi-Fi, WIMAX), SS7 signaling network, fixed line, local area network (LAN), wide area network (WAN), a direct point-to-point connection, mobile data networks (e.g., Universal Mobile Telecommunications System (UMTS), 3GPP Long-Term Evolution Advanced (LTE Advanced), Worldwide Interoperability for Microwave Access (WiMAX), etc.) and others, including any combination of these.

Server 106 is a computer server that is connected to network 104. Server 106 has a processor, volatile and non-volatile memory, at least one network interface, and may have various other input/output devices. As with all devices shown in the system 100, there may be multiple servers 106, although not all are shown.

The server 106 is in network communication with the one or more user devices 102. The server 106 may further be in communication with several databases such as an HCP profile database 110, a patient profile database 112, a drug distribution database 114, a simulation profile database 116. The databases 110, 112, 114 and 116 and the server 106 may be provided on the same server device, may be configured as virtual machines, or may be configured as containers. The server 106 and databases 110, 112, 114 and 116 may run on a cloud provider such as Amazon® Web Services (AWS®).

The server 106 may host a web application or an Application Programming Interface (API) endpoint that the one or more user devices 102 may interact with via network 104. The server 106 may make calls to the databases 110, 112, 114 and 116 to query HCP data, patient data, drug distribution data, simulation profile data, or other data received from the users of the one or more user devices 102. The requests made to the API endpoint of server 106 may be made in a variety of different formats, such as JavaScript Object Notation (JSON) or extensible Markup Language (XML).

The databases 110, 112, 114 and 116 may store HCP data, patient data, drug distribution data, simulation profile data, and configuration information respectively. The databases 110, 112, 114 and 116 may be a Structured Query Language (SQL) such as PostgreSQL or MySQL or a not only SQL (NoSQL) database such as MongoDB.

One or more LLM systems 108 are in network communication with the server 106. The LLM systems may be accessed by the server 106 using an API of the LLM system. The system may use an LLM (GPT-4 or similar) to generate HCP and patient profile components, as well as simulate interactions with a candidate marketing message or message-channel combination. The server 106 can transmit detailed prompts and predefined crafted prompts that enable the LLM to adapt to the volume and type of input data without making any modifications to its base model. The one or more LLM systems 108 may include one or more of the following:
GPT-2 made by OpenAI®
GPT-3 made by OpenAI®
GPT-Neo made by EleutherAI®
GPT-J made by EleutherAI®
Ernie 3.0 Titan made by Baidu®
Claude made by Anthropic®
LaMDA (Language Models for Dialog Applications) made by Google®
GPT-NeoX made by EleutherAI®
PaLM (Pathways Language Model) made by Google®
LLAMA (Large Language Model Meta AI) made by Meta®
GPT-4 made by OpenAI®
PaLM 2 (Pathways Language Model 2) Google®
Llama 2 made by Meta®

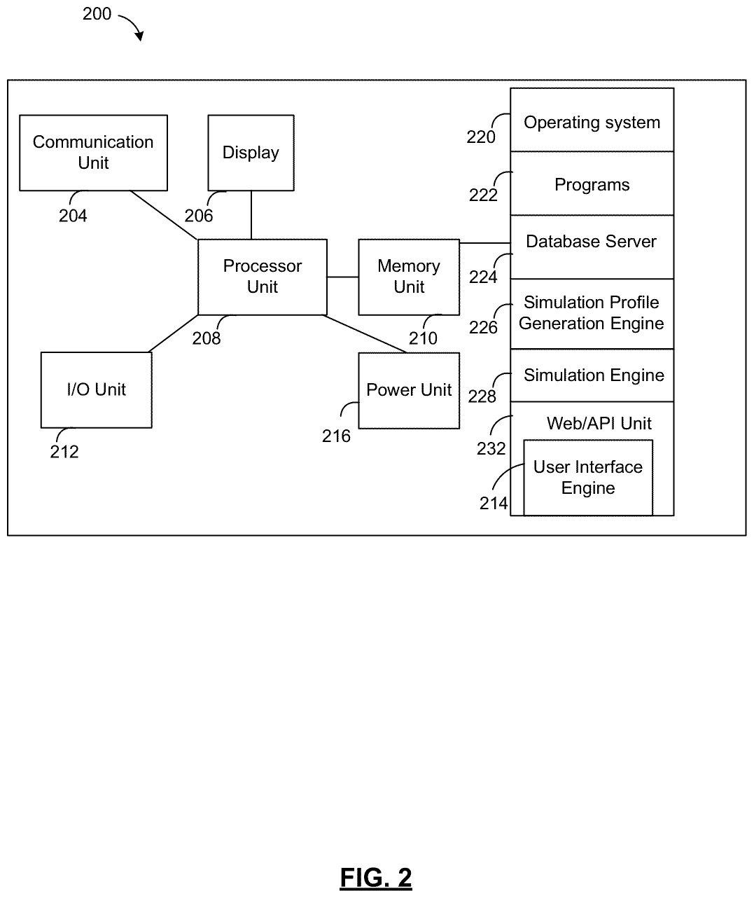

Referring next to FIG. 2, there is shown a block diagram for an example server device 200 that may be used as server 106 in the example system 100 shown in FIG. 1.

The communication unit 204 can include wired or wireless connection capabilities. The communication unit 204 can include a radio that communicates using standards such as IEEE 802.11a, 802.11b, 802.11g, or 802.11n. The communication unit 204 can be used by the server 200 to communicate with other devices or computers, such as a user device 102 and/or generative model 108. Communication unit 204 may communicate with a network, such as network 104 (see FIG. 1).

The display 206 may be an LED or LCD based display and may be a touch sensitive user input device that supports gestures. Optionally, display 206 may be omitted, for instance where the server 200 is a virtual server or is accessed through a separate device such as a user device 102.

The processor unit 208 controls the operation of the server 200. The processor unit 208 can be any suitable processor(s), controller(s) or digital signal processor(s) that can provide sufficient processing power depending on the configuration, purposes and requirements of the server 200 as is known by those skilled in the art. For example, the processor unit 208 may be a high-performance general processor. Alternatively or in addition, the processor unit 208 can include more than one processor with each processor being configured to perform different dedicated tasks. Alternatively or in addition, the processor unit 208 may include a standard processor, such as an Intel® processor or an AMD® processor.

The processor unit 208 can also execute a user interface (UI) engine 214 that is used to generate various Uls for delivery via a web application provided by the Web/API Unit 230, some examples of which are shown and described herein, such as interfaces shown in FIG. 3.

The memory unit 210 can include RAM, ROM, one or more hard drives, one or more flash drives or some other suitable data storage elements such as disk drives, etc. The memory unit 210 is used to store an operating system 220 and programs 222 as is commonly known by those skilled in the art.

The memory unit 210 further stores software code for implementing an operating system 220, programs 222, database server 224, simulation engine 228, and web/API unit 232.

The I/O unit 212 may include at least one of a mouse, a keyboard, a touch screen, a thumbwheel, a trackpad, a trackball, a card-reader, an audio source, a microphone, voice recognition software and the like again depending on the particular implementation of the server 200. Optionally, some of these components can be integrated with one another. Optionally, the I/O unit 212 may be omitted from server 106.

The user interface engine 214 can configured to generate interfaces for users to enable a user to interact with a user simulation application. For example, user interfaces may be provided to enable user to configure marketing message simulation, request a marketing message simulation, view marketing message simulation results, send and receive marketing message simulation results, etc. The various interfaces generated by the user interface engine 214 may be transmitted to a user device by virtue of the Web/API Unit 232 and the communication unit 204.

The power unit 216 can be any suitable power source that provides power to the server 200 such as a power adaptor or a rechargeable battery pack depending on the implementation of the server 200 as is known by those skilled in the art.

The operating system 220 may provide various basic operational processes for the server 200. For example, the operating system 220 may be a server operating system such as Ubuntu® Linux, Microsoft® Windows Server® operating system, or another operating system.

The programs 222 include various user programs. They may include several hosted applications delivering services to users over the network, for example, a marketing customer relations management (CRM) system.

The programs 222 may provide a marketing or advertising platform that is web-based, or client-server-based application via Web/API Unit 232 that provides for the creation and targeting of marketing campaigns. The programs 222 may provide a content management system like Veeva® Vault.

The database server 224 may be a database application providing the HCP profile database 110, the patient profile database 112, the drug distribution database 114, the simulation profile database 116 (see e.g., FIG. 1) for storing data associated with marketing message simulations. While the database server 224 is shown as operating on a single server 200 with the marketing message simulation system, it is understood that the database may be located separately on another server or system in network communication with the server 200. The database server 224 may store the HCP profile database, patient profile database, drug distribution database and the simulation profile database as flat files using naming conventions that aid in quick access and retrieval. HCP file names may follow the format HCP-profile-specialty-time_stamp-generated_ID, whereas patient file names use the format patient-profile-time_stamp-generated_ID.

The HCP profile database stored on database server 224 may include data corresponding to a plurality of HCPs. This may include name, organization, hospital affiliation, address information, medical specialty. Optionally, the HCP profile database may include historical prescribing behaviour of the plurality of HCPs. The HCP profile database may include data for large number of clinicians, such as doctors, specialists, pharmacists, nurses and other prescribing professionals. There may be a large number of HCPs in the database, including more than 1,000, 10,000, or more than 100,000.

The HCP profile database may include actual HCP profiles corresponding to actual HCPs and simulated HCP profiles corresponding to simulated HCPs created by the simulation profile generation engine.

Optionally, the HCP profiles can be generated based on real-world HCP profile data retrieved from a database storing HCP profile attributes for real-world HCPs. However, the real-world profile data may not include all desired profile attributes and/or the profile attributes may be defined inconsistently across the real-world HCP profiles.

Optionally, the HCP profile database can be populated entirely by simulated HCP profiles where at least one of the profile attributes of each HCP profile is generated artificially (e.g. simulated) for instance using an LLM system. This may ensure consistency in the format and definition of the HCP profile attributes for the entire set of HCP profiles to be used in a simulation.

Optionally, the simulated HCP profiles may include augmented HCP profiles that include simulated attribute fields in addition to attribute fields that include data from actual HCPs. The simulated attribute fields may be created by the simulation profile generation engine 226 and stored in the HCP profile database. For example, one or more simulated attributes that may be created using the LLM system using prompts include:
Age (may be passed in based on the HCP database data).
Gender (may be passed in based on the HCP database data)
Address (may be passed in based on the HCP database data)
Years of experience
Type of practice
Practice location
Medical school
Education background
Conference attendance
Relevant professional achievements
Affiliations with networks or organizations
Openness to New Treatment Modalities: (e.g., High/Medium/Low)
Reliance on Clinical Trials: (e.g., High/Medium/Low)
Trust in Pharmaceutical Reps: (e.g., High/Medium/Low)
Previous Experiences with Specific Drugs: (List any specific experiences or general sentiments)
Bias Towards Certain Treatments: (Any preferences or inclinations)
Preferred marketing channels (consider the following channels: Rep Visit, Tele-detailing, Email, Speaker Events, Banner Ads, Veeva Approved Emails, Teleconferences, Conferences)
Preconceived notions about the treatment of a condition (prompt: Include biases or preferences the HCP may have towards certain drug treatments based on their education, experiences, outcomes, evidences, or readings. The preconceived notions should be formatted in a way that they can be easily edited and updated with new information if needed. Preferably incorporated towards the bottom of the profile, making sure it aligns with the HCP's overall profile, the latest research and developments in their specialty. The drugs to have preconceived notions about will be passed in from the drug distribution database.)
Preferred treatment methods
Continuing education and professional development activities
The HCP's approach to staying updated on the latest research and specialty developments
Any philosophical approach to medicine and patient care, if relevant
Preconceived notions about drugs used to treat a condition

Optionally, the real-world HCP profile data can be used to seed the generation of simulated HCP profiles to address. One or more of the HCP profile attributes can be defined based on actual profile data corresponding to an actual healthcare provider. For example, some HCP profile attributes such as HCP name, HCP age, and/or HCP location can be predefined for the simulated HCP profiles (based on actual HCP names) to ensure that the simulated HCP profiles are more reflective of real-world data. This may prevent a generative LLM system from generating repetitive HCP profiles in which specific names, ages, or locations are over-represented due to biases in the LLM system. Accordingly, the simulated HCP profiles can be seeded using real-world data reflecting actual HCPs.

The patient profile database stored on database server 224 may include data corresponding to a plurality of patients or subjects. This may include name, age and gender. Optionally, the patient database may include historical prescription data for the patients. Optionally, the patient database may be pre-populated using USA Census data to return results that match the current US Census. This may be done to avoid inherent biases the LLM system may have in the generation of age and gender in patient profiles. The patient profile database may include data for large number of subjects across a particular geographical area. There may be a large number of subjects in the database, including more than 1,000, 100,000 or more than 1 million. Other simulated fields may be created by the simulation profile generation engine 226 and stored in the patient profile database. The patient profile database may be based on census data, or other statistical and/or survey collected data. For example, the simulated patient fields may include:
Gender (may be passed in based on the patient profile database data).
Age (may be passed in based on the patient profile database data).
Condition Severity (prompt: Choose from Mild, Moderate, Severe. This indicates the intensity and number of symptoms.)
Duration of Symptoms (prompt: Specify a duration, e.g., “3 months”, “2 years”. This can vary widely.)
Trigger or Significant Life Events (prompt: Specify if any events like job stress, loss of a loved one, etc., contributed to the onset of MDD symptoms.)
Duration of Condition Treatment (prompt: Specify the duration of the patient's MDD treatment or the number of treatment trials they have undergone.)
Medication History (prompt: Based on 1-2 medications specified below, discuss how well the medications work in terms of symptom relief and side effects experienced by the patient.)
Response to Previous Treatments (prompt: Specify if the patient was non-responsive, had a partial response, or a complete response to any previous treatments.)

These simulated patient fields may be created using a prompt that is sent to the LLM system specifying the output.

The drug distribution database stored on database server 224 may include data corresponding to a plurality of medications. This may include ICD9 indication, drug name, and the amount of those drugs prescribed in the sum of all those ICD9 events.

Summarized drug distribution data may be stored for each ICD9 code.

The drug distribution database may include data for large number of medications across a variety of therapeutic indications. There may be a large number of medications in the database, including more than 100, 1,000, or 10,000. Other simulated fields may be created by the simulation profile generation engine 226 and stored in the drug distribution database.

The simulation profile database stored on database server 224 may include data corresponding to the marketing messages simulated herein. This may include a simulated HCP reaction, a simulated HCP reaction rationale, a statistical likelihood of the HCP prescribing behavior. For example, the HCP prescribing behavior may include a list of five simulated prescribed drugs which may be used to analyze the marketing impact on prescription behavior.

The HCP reaction may include, for example, ignore (−1), unchanged (0), or convinced (1). The HCP reaction can be defined as a quantitative measure of the simulated reaction of the corresponding HCP profile to a marketing message.

The HCP reaction may be associated with a rationale or reason. The reaction rationale can provide a qualitative basis that explains the underlying logic or justification for the HCP reaction based on the content of the corresponding HCP profile. The HCP reaction rationale may be generated by the LLM during the simulation. The simulation engine 228 may output an HCP reaction and associated HCP reaction rationale as, for example, “1, As a healthcare professional open to new treatment modalities and regularly engaging with email communication, I find the data provided in the $BRAND email interesting and persuasive. This may lead me to reconsider my current preference for $COMPETITOR as the first-line treatment and explore the potential benefits of $BRAND in appropriate cases, given the evidence presented on its effectiveness in relieving overall symptoms of $CONDITION.”

The simulation profile database may include data for large number of simulations performed by the system herein. There may be a large number of simulation profiles stored in the database, including more than 10,000, 100,000, millions or billions.

The simulation profile generation engine 226 may be used to create or construct new fields for the records in the HCP profile database stored on database server 224, the patient profile database stored on database server 224, and the drug distribution database in database server 224. The profile generation engine 226 may generate HCP profiles and patient profiles using real-world data (e.g. seeding from real-world HCP profiles) and the LLM system. The data modules may distribute census data, pre-filter relevant specialties for HCPs, and sample prescription patterns according to the drug indication being simulated. The simulation engine 228 may use these generated profiles as inputs while simulating interactions between HCPs, patients, and marketing messages.

The simulation engine 228 provides integration with the LLM system. This may include a variety of LLMs such as those described for LLM system 108 (see FIG. 1). The simulation engine 228 can generate a prompt request to be sent to an LLM to simulate a marketing reaction. The prompt request can include a sequence of events to be simulated by the LLM. The event sequence may be a sequence of simulated events. The sequence of simulated events may be randomly generated, user generated (based on specific hypotheses or real-life campaigns), or according to a defined model, such as a marketing mix model.

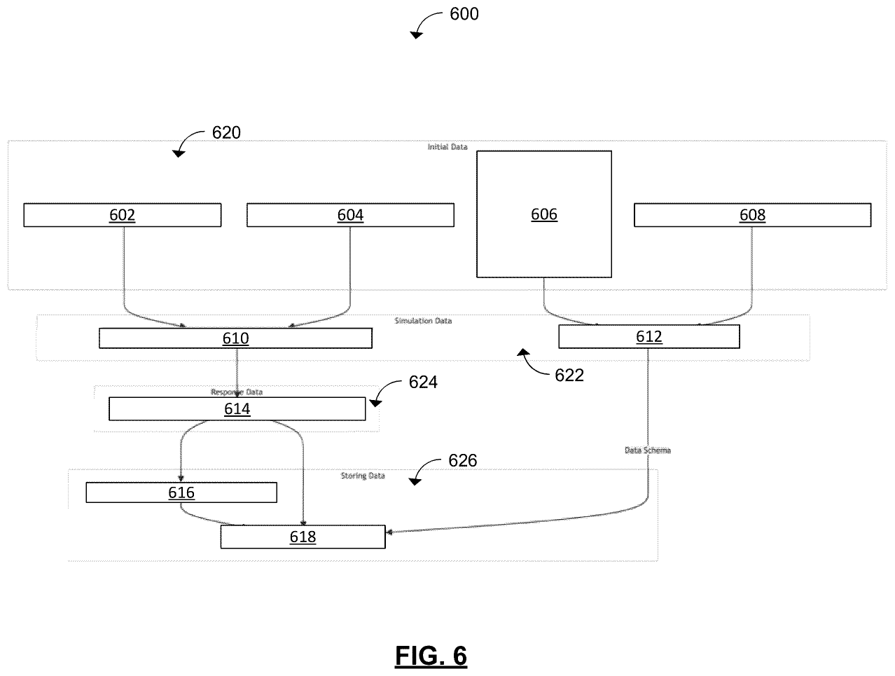

The simulation engine 228 may build a simulation data frame such as the example data frame shown in FIG. 6. The simulation engine 228 may include the data frame in the prompt request sent to the LLM system including the sequence of events. The data frame may be pre-populated with an initial sequence derived from the sequence data. The data frame may define the quantitative basis for the simulation process to be performed by the LLM system.

The simulation engine 228 may include other data from the HCP profile database, the patient profile database and the drug distribution database in the prompt request. Optionally, the data included in the prompt request may be randomly selected.

Alternatively, the data included in the prompt request may be user-selected. A user may select particular patient and/or HCP profiles to include in the prompt request. This user-selection can include constructed data, as well as particularly selected specialties of doctors. Optionally, a user may define a set of user-defined data constraints that specify a subset of the stored data to be included in the prompt request. For instance, the user may specify a required specialty for the HCP profiles to be included in the prompt request. Optionally, the data included in the prompt request may be randomly selected in accordance with the user-defined data constraints.

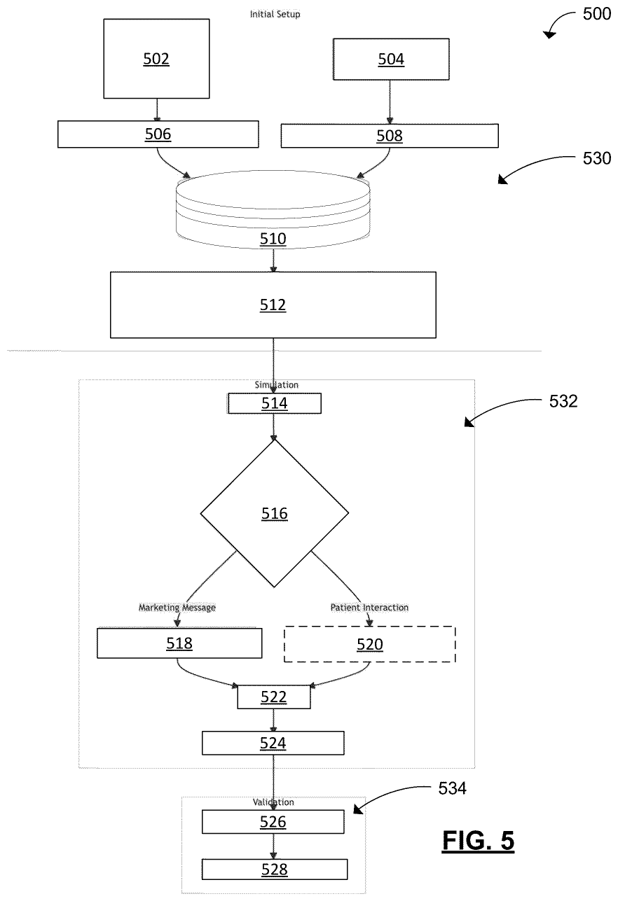

The simulation engine 228 may accommodate different simulation pathways (see FIG. 5) that accommodate various message-channel combinations. Examples of message-channel combinations can include traditional and modern digital marketing approaches such as face-to-face interactions, social media, email marketing, representative visits, tele-detailing, speaker events, banner ads, teleconferences, conferences and the ability to execute random, handcrafted, marketing mix model, or other custom campaign structures.

The simulation engine 228 may receive a response from the LLM system based on the prompt request. For example, the response may be “{“Moltraline”: “Effective results, tolerable side effects”, “Rioxetine”: “Minor sexual dysfunction, cognitive advantages”, “Zapamirtine”: “Alleviation of anxiety, few instances of sexual dysfunction”, “Hexaflexine”: “Assistance with anxiety, balanced occurrence of side effects”, “Lunicitram”: “Proven to work, potential for lesser side effects”} ”. The response from the LLM includes variables recording the reaction(s) to the marketing message (reaction_to_message). The response from the LLM may also include variables recording the resulting prescription decision (resulting_rx_decision).

The simulation engine 228 may receive a response such as, if the HCP ignores the channel entirely, respond with −1.—If the HCP accepts the channel and message but has no impact, respond with 0, followed by the HCP's perception of the message. If the HCP accepts the channel and message and updates their profile, respond with 1, followed by the new updated perception.

The Web/API Unit 232 may be a web-based application or Application Programming Interface (API) such as a REST (REpresentational State Transfer) API. The API may communicate in a format such as XML, JSON, or other interchange format.

The Web/API Unit 232 may receive a marketing message simulation request including a marketing message, may apply methods herein to determine a marketing message simulation, and then may provide the results in a marketing message simulation response. The marketing message, values determined from the marketing message or its metadata, and other metadata from the user device may be stored after receipt of a marketing message simulation request in database server 224. The results of the marketing message simulation may be associated with the marketing message and stored in the database server 224.

Referring next to FIG. 3, there is shown a diagram of an example user interface 300. The user interface 300 may be a browser, or an application based user interface. The user interface 300 includes a marketing message portion 304 including a user input control 306, an event sequence portion 308, an HCP reaction portion 310, and a marketing message prescription lift statistics portion 312.

As illustrated, the marketing message portion 304 includes a user input control 306 that enables a user to input different candidate marketing messages that may be simulated through their user device. The user may include several different marketing messages at the same time in order to provide a comparative simulation between the performance of the different messages. The user may type the marketing messages in the user input control 306, and then once ready may submit the marketing messages for simulation using the simulation submission button 314. Alternatively, a user may upload a list or file containing one or more marketing messages to be simulated. Optionally, the user may also define candidate message-channel combinations for the candidate marketing messages.

The output of the simulation process, including intermediate outputs during the simulation process, may be displayed in event sequence portion 308. The event sequence portion 308 may include a text summary, a statistical summary, or a visualization of the generated event sequence used for simulation including marketing message events and patient interaction events.

The output of the simulated marketing message reaction (once the simulation completes) may be displayed in HCP reaction portion 310. The HCP reaction portion 310 may include a text summary, a statistical summary, or a visualization of the simulated HCPs and their reactions to the various marketing messages submitted by the user in user control 306 in marketing message portion 304.

The output of the simulated marketing message reaction (once the simulation completes) may be displayed in marketing message prescription lift statistics portion 312 or stored in a database. The marketing message prescription lift statistics portion 312 may include a text summary, a statistical summary, or a visualization of the simulated changes in prescribing behaviour based on the various marketing messages in submitted by the user in user control 306 in marketing message portion 304.

Alternatively, a graphical user interface may be omitted. For example, a user may interact with the user simulation application using a command line interface. A user may input command-line scripts to perform various functions associated with simulating a marketing reaction, including for example generating HCP profiles, validating generated HCP profiles, running a simulation, validating simulation results, analyzing simulation results, exporting simulation results, visualization simulation results, and so forth.

The command line interface may provide a user with enhanced flexibility that is not constrained by the options presented through a graphical user interface. For example, a user may have enhanced control over the parameters of each function, using user-defined scripts. The command-line interface may also allow a user to use or create other tools for the simulation process, for instance by adding or combining additional predefined or custom scripts into the command line interface.

Optionally, a plurality of predefined scripts may be stored in a script library or database on a memory accessible to the user device 102 and/or server 106. The predefined scripts can include script templates usable as command-line scripts to perform the various functions associated with simulating a marketing reaction. A user of the user device 102 may select a predefined script and input the predefined script to the command-line interface to cause the corresponding function to execute. Optionally, a user may modify a portion of the script template to generate a custom script for a particular simulation run.

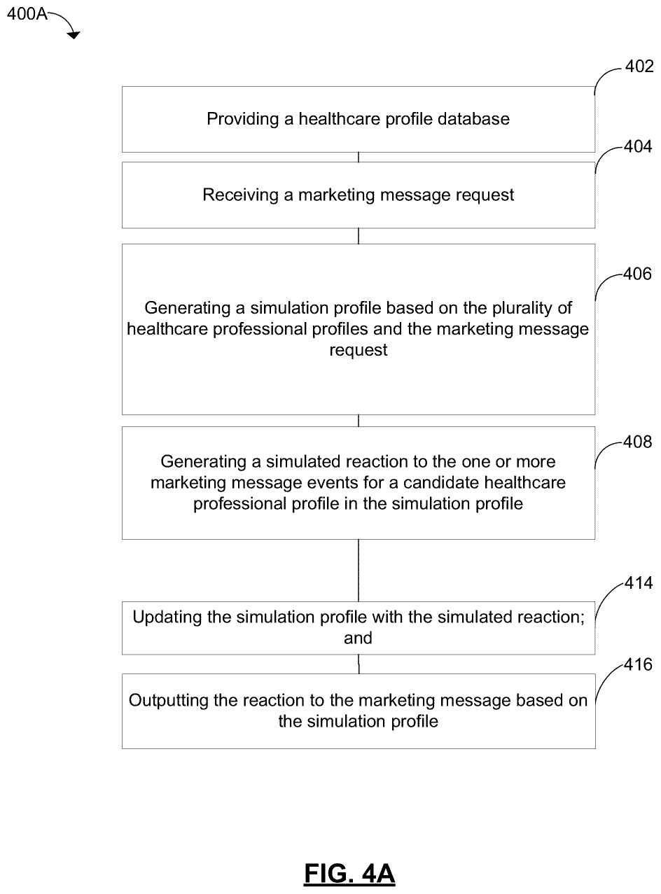

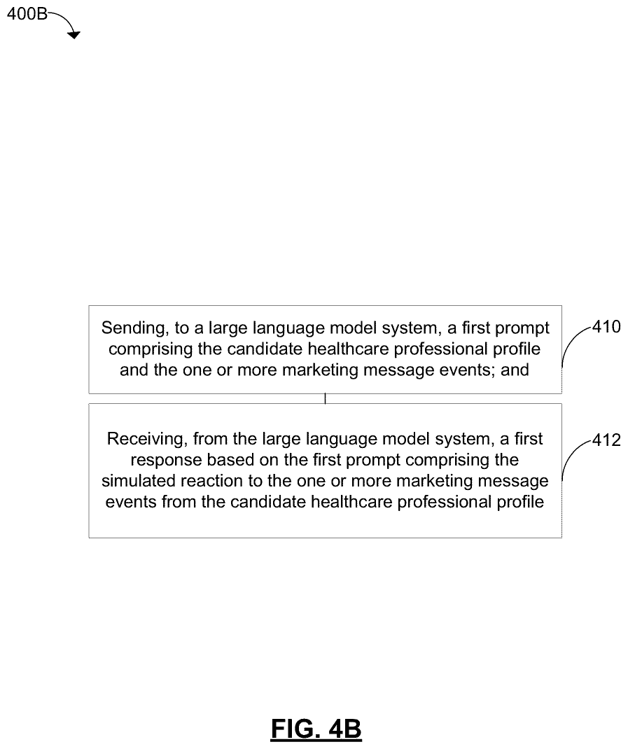

Referring next to FIG. 4A, there is shown a flowchart of an example method 400A for simulating a reaction to a marketing message.

At 402, a healthcare profile database can be provided at a memory. The healthcare profile database can include a plurality of healthcare professional profiles.

At 404, a marketing message request can be received by the server. The marketing message request can include one or more marketing messages. The marketing message request can specify one or more candidate marketing messages to be tested. Each candidate marketing message can be predefined by the user.

The marketing message request may also specify one or more message-channel combinations to be tested. Optionally, the marketing message request may specify one or more candidate marketing messages and one or more marketing channels without necessarily specifying any particular combination of marketing message and channel.

At 406, a simulation profile is generated at a processor in communication with the memory. The simulation profile can be generated based on the plurality of healthcare professional profiles and the marketing message request. Optionally, the simulation profile may also be generated based on a plurality of patient profiles. Each simulation profile can be defined to include an event sequence. The event sequence can include one or more marketing message events for an HCP profile. Optionally, the event sequence can include one or more patient interaction events.

At 408, a simulated reaction to the one or more marketing message events can be determined for a candidate healthcare professional profile in the simulation profile. Step 408 may be repeated for each candidate marketing message (or candidate message-channel combination) and each HCP profile in the simulation profile. For example, a plurality of simulated reactions can be generated in a “round-robin” manner in which the reaction of every HCP profile to every candidate marketing message (or message-channel) is simulated (i.e. for each HCP profile, a plurality of reactions are generated with each reaction corresponding to one of the candidate marketing messages or message-channel combinations to be simulated).

Referring now to FIG. 4B, shown therein is an example method 400B for generating a simulated reaction. Method 400B can be used, for example, to generate a simulated reaction at step 408 of method 400A.

At 410, a message reaction prompt can be sent to a large language model system to cause the LLM system to output a message reaction response. The message reaction prompt can include the candidate healthcare professional profile and the one or more marketing message events. The message reaction prompt can also include reaction simulation instructions that instruct the LLM system to simulate a reaction of an HCP corresponding to the candidate healthcare professional profile to each marketing message (and optionally message channel) defined in the one or more marketing message events.

Optionally, a set of message reaction prompts can be sent to the large language model system. The set of message reaction prompts can be defined to cause the LLM system to output a message reaction response for each combination of HCP profile and candidate marketing message (or message-channel combination). Optionally, the set of message reaction prompts can be sent to the large language model system using a message reaction prompt script that is defined to cause the set of message reaction prompts to be sent to the large language model system in sequence. The message reaction prompt script can then automatically manage the simulation of the desired HCP reactions through a sequence of prompts and response to the LLM system.

Optionally, the set of message reaction prompts may be sent to multiple generative LLM processors concurrently or in parallel. Optionally, message reaction prompt script can define the number of concurrent reactions to simulate.

At 412, a message reaction response can be received from the large language model system. The message reaction response can be output by the LLM system in response to the message reaction prompt. The message reaction response can include a simulated reaction to each marketing message event from the candidate healthcare professional profile. As noted herein above, the message reaction response can include an HCP reaction for the candidate healthcare professional profile for each marketing message event. The message reaction response may also include an HCP reaction rationale associated with each HCP reaction.

Referring again to method 400A, at 414, the simulation profile can be updated with the simulated reaction(s). Steps 408 and 414 may be repeated for each candidate healthcare professional profile in the simulation profile.

At 416, the reaction(s) to the marketing message based on the simulation profile can be output. This can include outputting a file containing the reactions of each candidate healthcare professional profile in the simulation profile. Optionally, the reactions of each candidate healthcare professional profile in the simulation profile can be displayed on a display device (e.g. on user device 102). Optionally, a visualization of the reactions of the candidate healthcare professional profiles in the simulation profile can be generated and displayed on a display device (e.g. on user device 102).

Optionally, the method may further include: providing, at the memory, a patient profile database comprising the plurality of patient profiles; generating, at the processor, a simulated patient interaction between the candidate healthcare professional profile and a candidate patient profile, the simulated patient interaction determined by: sending, to the large language model system, a second prompt comprising the candidate healthcare professional profile and the candidate patient profile; and receiving, from the large language model system, a second response comprising the simulated patient interaction; wherein the simulated reaction may comprise the simulated patient interaction.

The simulation, of either reaction to the one or more marketing message evenings or the patient interaction events, may be performed by prompting the LLM system to roleplay as the HCP, the patient, or both the patient and the HCP, and react to either the patient (or marketing message) appropriately.

Optionally, a data frame may be generated, and the generating the simulated reaction may comprise sending the data frame to the large language system.

Optionally, the simulated patient interaction may comprise at least one medication treatment recommendation.

Optionally, the method may further include: providing, at the memory, a drug distribution database; generating, at the processor, a simulated prescription behavior of the candidate healthcare professional profile for one or more medications in the drug distribution database, the simulated prescription behavior comprising one or more predicted prescriptions, the simulated patient interaction determined by: identifying the one or more medications in the drug distribution database based on an ICD-9 code; sending, to the large language model system, a second prompt comprising the candidate healthcare professional profile and the corresponding drug distributions of the one or more medications; and receiving, from the large language model system, a second response comprising the simulated prescription behavior; wherein the simulation profile may comprise the simulated prescription behavior.

Optionally, the simulated prescription behavior may comprise one or more medications generated by the large language model system.

Optionally, the generating the simulation profile may comprise sending, to the large language model system, the candidate healthcare professional profile; receiving, from the large language model system, a simulated component of the candidate healthcare professional profile; and updating the candidate healthcare professional profile with the simulated component.

Optionally, the generating the simulation profile may comprises sending, to the large language model system, the candidate patient profile; receiving, from the large language model system, a simulated component of the candidate patient professional profile; and updating the candidate patient profile with the simulated component.

Optionally, the method may further include providing, at the memory, a simulation profile database; and wherein the generating the simulation profile may comprise storing the simulation profile in the simulation profile database.

Optionally, the method may further include normalizing the one or more predicted prescriptions of the simulation profile.

Optionally, the simulated reaction may comprise one of a simulated ignore, an unchanged reaction, or a convinced reaction.

Optionally, the simulated reaction may comprise a simulated rationale associated with the simulated reaction.

Referring next to FIG. 5, there is shown a flowchart of another example method 500 for simulating a marketing reaction.

In an initial simulation setup mode 530, data may be created, constructed or augmented based on the existing HCP data in the HCP database and the patient data in the patient database.

At 502, inputs from a real-world healthcare provider database can be gathered. This can include some real-world profile attributes such as, for example, HCP name, organization, hospital affiliation, address (including city, state or province, specialty, etc.), and medical specialty.

At 506, the inputs from 502 are sent to an LLM system in a profile creation prompt. The prompt includes a request to create an HCP profile based on the inputs. The prompt response from the LLM system may include one or more HCP profiles that can be stored in the simulation database 510 in association with a simulation profile.

The profile creation prompt can specify the generation of a target number of HCP profiles. A profile creation prompt template can be defined that requires a user to specify the target number of HCP profiles to include in the prompt. Optionally, the profile creation prompt template can include a default target number that can be adjusted by a user as required.

The profile creation prompt can define a set of attributes to be included in each HCP profile. The profile creation prompt can also include attribute constraints for each of the attributes to be included in the HCP profiles. The attribute constraints can specify acceptable values or value ranges that can be included in an HCP profile for each attribute. Optionally, the profile creation prompt may include one or more real-world attribute values for one or more attributes in the set of attributes. The real-world attribute values can be used to seed the generation of the HCP profiles by predefining certain profile attributes using real-world attribute data. Optionally, the real-world attribute values may not be defined directly but may be defined instead using pointers to corresponding data in other files (e.g. in real-world data retrieved from the real-world healthcare provider database).

Optionally, a profile creation prompt template can include a default set of attributes for the generation of an HCP profile. Optionally, a user may adjust the set of attributes included in the profile creation prompt template to add and/or remove attributes from the set of attributes for a given HCP profile generation.

Optionally, the attribute constraints can include statistical distribution data usable to generate the target number of HCP profiles with attributes that correspond to a desired statistical distribution. For example, the desired statistical distributions can be defined based on real or realistic HCP demographics for target recipients of a marketing message. The statistical distribution data can constrain the generation of the HCP profiles by the LLM system to ensure that the generated profiles generally represent a random or pseudo-random set of HCPs that are likely to be target recipients of the marketing message.

The desired statistical distributions can be defined based on various sources of real-world statistical data relevant to the candidate marketing message(s) to be tested. Examples of data sources include public or proprietary databases accessible to the server 106 storing HCP data relating to HCPs in a relevant specialty, public or proprietary databases containing marketing research data relating to the specialty and/or disease in question, public or proprietary databases containing research data relating to the specialty and/or disease in question, and so forth. The desired statistical distributions can be defined based on the most relevant available data, for instance data gathered specifically in relation to a particular disease or specialty, data corresponding to a market relevant to the marketing message (e.g. a specific geographic location) and/or the most recent available data.

The set of attributes in the profile creation prompt can include an HCP segment attribute. The HCP segment attribute can specify a particular market segment associated with the HCP profile. The profile creation prompt can also include HCP segment constraints that specify the available segments to which an HCP profile can be assigned. The HCP segment constraints can include a desired segment distribution. The desired segment distribution can specify the distribution of HCP segment attributes across the plurality of HCP profiles to be generated.

The profile creation prompt template can include a user-adjustable HCP segment attribute. The user-adjustable HCP segment attribute can enable a user to specify the available segments for the HCP profiles to be generated. The user-adjustable HCP segment attribute can also enable a user to specify the distribution of the available segments and/or the probability of each segment being assigned to a given HCP profile.

The set of attributes in the profile creation prompt can include an HCP experience attribute. The HCP experience attribute can specify the experience (e.g. number of years of experience) associated with the HCP profile. The profile creation prompt can also include HCP experience constraints that specify the available range of experience that can be included in an HCP profile. The HCP experience constraints can include a desired experience distribution. The desired experience distribution can specify the distribution of HCP experience attributes across the plurality of HCP profiles to be generated.

The profile creation prompt template can include a user-adjustable HCP experience attribute. The user-adjustable HCP experience attribute can enable a user to specify the range of experience values that can be included in the HCP profiles to be generated. The user-adjustable HCP experience attribute can also enable a user to specify the distribution of the available experience levels and/or the probability of each level of experience being assigned to a given HCP profile.

The set of attributes in the profile creation prompt can include an HCP practice setting attribute. The HCP practice setting attribute can specify the type of practice associated with the HCP profile (e.g. academic setting, community setting, hospital setting etc.). The profile creation prompt can also include HCP practice setting constraints that specify the available practice settings that can be included in an HCP profile. The HCP practice setting constraints can include a desired practice setting distribution. The desired practice setting distribution can specify the distribution of HCP practice setting attributes across the plurality of HCP profiles to be generated.

The profile creation prompt template can include a user-adjustable HCP practice setting attribute. The user-adjustable HCP practice setting attribute can enable a user to specify the available practice setting types that can be included in the HCP profiles to be generated. The user-adjustable HCP practice setting attribute can also enable a user to specify the distribution of the available practice setting levels and/or the probability of each practice setting being assigned to a given HCP profile.

The set of attributes in the profile creation prompt can include an HCP practice location attribute. The HCP practice location attribute can specify a location type (e.g. rural, urban, suburban or geographic region) of the practice associated with the HCP profile. The profile creation prompt can also include HCP practice location constraints that specify the available practice locations that can be included in an HCP profile. The HCP experience constraints can include a desired practice location distribution. The desired practice location distribution can specify the distribution of HCP practice location attributes across the plurality of HCP profiles to be generated.

The profile creation prompt template can include a user-adjustable HCP practice location attribute. The user-adjustable HCP practice location attribute can enable a user to specify the types of practice locations that can be included in the HCP profiles to be generated. The user-adjustable HCP practice location attribute can also enable a user to specify the distribution of the available practice locations and/or the probability of each practice location being assigned to a given HCP profile.

The set of attributes in the profile creation prompt can include an HCP practice volume attribute. The HCP practice volume attribute can specify the volume of patients seen by the HCP associated with the HCP profile. The profile creation prompt can also include HCP practice volume constraints that specify the available range of average patient volume that can be included in an HCP profile. The HCP practice volume constraints can include a desired practice volume distribution. The desired practice volume distribution can specify the distribution of HCP practice volume attributes across the plurality of HCP profiles to be generated.

The profile creation prompt template can include a user-adjustable HCP practice volume attribute. The user-adjustable HCP practice volume attribute can enable a user to specify the range of patient volume values that can be included in the HCP profiles to be generated. The user-adjustable HCP practice volume attribute can also enable a user to specify the distribution of the available practice volumes and/or the probability of each practice volume being assigned to a given HCP profile.

The profile creation prompt can specify the context and purpose for the generation of the HCP profiles for a given simulation. For example, the profile creation prompt can include background data, context data, and/or specific instructions for the LLM, such as specifying medical conditions, treatment landscapes, or market dynamics to be used in the particular simulation.

A plurality of simulated healthcare professional profiles can then be generated by transmitting the profile creation prompt to the large language model. The plurality of simulated healthcare professional profiles can then be received as an output from the large language model. The plurality of simulated healthcare professional profiles may include a minimum viable number of simulated HCP profiles. For example, 100 simulated profiles may be specified as the minimum viable number of simulated HCP profiles to be included in the marketing reaction simulation process. A greater number of HCP profiles, for instance 1000 HCP profiles, may be defined as a desired number of valid HCP profiles to be generated. This may ensure sufficiently variability across the simulated profiles (to reflect real-world demographic differences) while ensuring that the simulation results (while inherently random) generally converge to a statistically useful result.

An example of a profile creation prompt used at 506 for a single HCP profile may be, for example, “Create a detailed healthcare professional (HCP) profile for a marketing campaign simulation based on the information string provided. The information string will always include the following fixed details: name, organization, hospital affiliation, city, state, country, and specialty. Use this fixed information as a starting point and fill in the other requested elements.” Then, the prompt may include a listing of any simulated HCP fields to be created, for example, those listed above for HCP profile database stored on database server 224. The prompt may continue “Develop a comprehensive HCP profile that can be utilized in a marketing campaign simulation.” The prompt may then include an information string based upon known information about the particular HCP based on known information in the HCP database stored on database server 224.

The response from the LLM system at 506 may be, for example:
Name: Dr. Anna Jones
Organization: Springdale Mental Health Clinic
Hospital Affiliation: Springdale General Hospital
City: Springdale
State: Arkansas
Country: United States
Specialty: Clinical Psychologist
Age: 45
Gender: Female
Years of experience: 20
Type of practice: Private Practice
Practice location: Springdale Mental Health Clinic
Medical school: University of Arkansas for Medical Sciences
Education background: Bachelor's Degree in Psychology, University of Arkansas; Ph.D. in Clinical Psychology, University of Arkansas for Medical Sciences

Optionally, a plurality of HCP profiles can be generated using a profile creation script. The profile creation script may specify the number of HCP profiles to be generated along with the attributes and constraints for the profile creation prompt to be provided to the LLM system. The profile creation script can then automatically manage the creation of the desired number of HCP profiles through a sequence of prompts and response to the LLM system.

Optionally, the plurality of HCP profiles can be generated by concurrently generating a plurality of HCP profiles. For example, the profile creation script can specify a number of concurrent HCP profile generation simulations to perform concurrently. This allows the server 106 to process multiple LLM interactions simultaneously, enhancing performance and reducing simulation time. The number of concurrent HCP profile generation simulations to perform concurrently may be limited based on network or access constraints and/or to minimize or avoid corruption in the generation of the HCP profile.

Optionally, a profile validation process can be used to validate the HCP profiles generated at 506. The profile validation process can be performed to validate the individual HCP profiles generated at 506. For example, the profile validation process can compare each HCP profile to a predefined HCP profile format to ensure that each HCP profile has been generated in accordance with the desired format. The profile validation process can also ensure that HCP profile data is not lost or corrupted as a result of generating a plurality of HCP profiles concurrently.

The profile validation process can also be performed to validate the set of HCP profiles generated at 506. That is, the set of HCP profiles can be analyzed to ensure that the generated HCP profiles correspond to the desired statistical distributions. For example, the distribution of profile attributes in the plurality of simulated healthcare professional profiles can be validated by automatically comparing the profile attributes of each simulated healthcare professional profile received from the large language model to the plurality of attributes distribution sets defined in the profile creation prompt.

A user can initiate the profile validation process by inputting an HCP validation prompt through the user device 102. The HCP validation prompt can be defined based on the attributes and other parameters defined in the profile creation prompt.

In some cases, one or more invalid simulated healthcare professional profiles may be identified through the profile validation process. Each of the invalid simulated healthcare professional profiles can then be omitted or removed from the plurality of healthcare professional profiles included in the simulation profile.

The profile validation process can be defined to ensure that the HCP profiles output by the LLM system are defined in accordance with predefined formatting rules. For example, the format of the HCP profile may be predefined to facilitate downstream analysis and debugging. The profile validation process can compare the simulated HCP profiles to the predefined formatting rules to determine whether the simulated HCP profiles are valid.

Optionally at 504, inputs from the patient database are gathered. This can include age, gender, name, address, or other information associated with patients. Step 504 may be omitted, for example, where patient interactions are not included as part of the simulation profile.

At 508, the inputs from 504 are sent to an LLM system in a prompt. The prompt includes a request to create a patient profile based on the inputs. The prompt response from the LLM system may include one or more patient profiles that can be stored in the simulation profile database 510 in association with a simulation profile. The prompt used at 508 may be, for example, “Generate a patient micro profile for a scenario: ” Then, the prompt may include a listing of any simulated patient fields to be created, for example, those listed above for patient database stored on database server 224. The prompt may continue “Here is the gender, age and 1-2 medications for this patient profile: ”, and then may append known patient information from the patient database stored on database server 224.

The response from the LLM system at 508 may be, for example:
1. Gender: Female
2. Age: 80 years old
3. MDD Severity: Moderate
4. Duration of Symptoms: 1 year
5. Trigger or Significant Life Events: Loss of spouse and various health issues contributed to the onset of MDD symptoms.
6. Duration of MDD Treatment: The patient has been under treatment for 10 months and has undergone 2 treatment trials.
7. Medication History: The patient was initially prescribed bupropion which provided some relief in depressive symptoms, but side effects such as headaches and insomnia warranted a switch to paroxetine. With paroxetine, the patient experienced moderate improvement in mood, but also experienced side effects like weight gain and drowsiness.
8. Response to Previous Treatments: The patient had a partial response to both bupropion and paroxetine, with some improvement in depression symptoms but continued side effects and an overall incomplete resolution of MDD symptoms.

Step 508 may be omitted, for example, where patient interactions are not included as part of the simulation profile.

The simulation profile database 510 may be, for example, the simulation profile database 116. The simulation profile database 510 can store constructed HCP profiles from step 506. Optionally, the simulation profile database 510 can store constructed patient profiles from 508. Further optionally, the simulation profile database 510 may store constructed drug distribution profiles.

Optionally, at 512 an event sequence can be generated. The event sequence can be generated by sending an event sequence request to the LLM system. The event sequence request can include the simulation profile from 510 that contains the HCP profiles and optionally patient profiles. The event sequence request can also include one or more candidate marketing messages to be evaluated.

Optionally, each candidate marketing message can also have one or more associated marketing channels. Each combination of a candidate marketing message and an associated marketing channel may be referred to as a message-channel combination. The event sequence request can include one or more message-channel combinations for the one or more candidate marketing messages to be evaluated.

The simulation event sequence can include an HCP event sequence for each HCP profile. The HCP event sequence for each HCP profile can include a candidate message event sequence specifying the candidate marketing messages (and/or message-channel combinations) to be provided to that HCP profile during the simulation.

The event sequence may be created with user specified parameters such as:
Number of HCPs to run through simulation
Number of marketing messages (or message-channels combinations) for each HCP

Optionally, the HCP event sequence for an HCP profile can include a pre-determined number of patient interactions with patients identified in the patient profiles of the simulation profile. This event sequence may identify a number of unique patients, or a number of repeat visits from the same patients. Optionally, the event sequence may then include additional user specified parameters such as a number of patient visits and a number of repeat visits.

Optionally, the generation of an event sequence may be omitted. For instance, the simulation profile can be defined to simulate each marketing message and/or each message-channel combination for each HCP profile contained in the simulation profile.

At 532, a simulation mode or phase may begin in order to simulate the events associated with the simulation profile and optionally the event sequence.

While two simulation paths are shown, i.e., the marketing message 518 and the patient interaction 520, other simulation paths are possible. The system allows for custom campaign structures or marketing mix models to be implemented as simulation paths. The user may define message-channel combinations and the sequence of events for each simulation path. This provides flexibility in exploring different marketing strategies and evaluating their effectiveness in the HCP simulator.

At 514, each HCP event sequence (i.e., the event sequence for each HCP in the simulation profile) or each marketing message and/or each message-channel combination for each HCP profile may be iteratively analyzed using the LLM system.

Optionally, at 516, this can include, for each event in the event sequence, determining whether the next event is a patient interaction or a marketing message to an HCP. Alternatively, steps 516 and 520 may be omitted where patient interactions are not included in the simulation profile.

At 518, if the event is a marketing message to an HCP, a marketing message simulation request can be sent to the LLM system. A response can be received from the LLM system recording the reaction to the marketing message based on the simulation profile. The HCP response may be stored in the simulation profile in the simulation profile database 510.

The prompt for an individual marketing message simulation request to the LLM system may, for example, include “You're an AI that analyzes healthcare professional's (HCP) reaction to a specific drug message and channel based on their profile. The task involves determining their engagement level, the persuasiveness of the message, and if it changes their initial preferences. Steps: 1. Rate the HCP's engagement with the channel and message (ignore=‘−1’, accept but no impact=negative, accept and update profile=positive). 2. Assess message quality and persuasiveness as needed per chosen code. 3. For positive codes, provide an updated preference or notion. 4. For negative codes, reflect HCP's message perception.”

Optionally, at 520, if the event is a patient interaction, a patient interaction simulation request is sent, and a response is received from the LLM system recording the reaction to the patient interaction based on the simulation profile. This may include listing prescriptions that may be issued for the patient by the simulated HCP. The patient interaction may be stored in the simulation profile in the simulation profile database 510. The prompt for the patient interaction simulation request may be, for example, “Roleplay as the doctor outlined in #HCP Profile and generate a JSON-style list of five drug recommendations for the patient experiencing the Disorder as described in the #Patient Profile section. Consider both the #HCP Profile and #Patient Profile sections when making these recommendations. Provide a brief reason (10 words or less) for each recommendation.

At 522, the results of the simulation including the results of the simulated marketing messages and the simulated patient interactions (if any), as well as metadata associated with the interactions, and any summary statistics for the series of events, is recorded in the simulation profile database.

At 524, if there are alternative marketing messages that are candidates for the marketing message simulation, those may be executed iteratively or in parallel. This may allow multiple marketing messages to be simulated at the same time for the same patient and HCP populations, and the results of the simulations may be compared to identify any particularly advantageous marketing messages based on the simulation.

Alternatively, only a single simulation path may be used. For example, the patient interaction simulation path may be omitted and only the reactions to marketing messages may be simulated.

A marketing reaction-specific simulation can be initiated that simulates the reaction of each HCP profile in the simulation profile to each marketing message (or message-channel combination) in the simulation profile. The marketing-reaction specific simulation can generate a simulated reaction set for each candidate marketing message (or message-channel combination). The simulated reaction set can be generated by generating a simulated reaction to that marketing message for each healthcare professional profile in the plurality of simulated healthcare professional profiles.

The marketing reaction-specific simulation can be initiated by inputting a run simulation script through the user device 102. The run simulation script can identify the plurality of HCP profiles and marketing messages (or message-channel combinations) either directly or by reference to a directory or file containing the respective HCP profiles or marketing messages.

The run simulation script can include, or reference, an interaction prompt to be provided to the LLM system to simulate the marketing message reactions. For example, a prompt similar to the prompt for an individual marketing message simulation request may be used to simulate the marketing message reactions. The run simulation script may specify that an instance of the prompt for an individual marketing message simulation request be sent to the LLM system for each combination of HCP profile and marketing message (message-channel combination) to be simulated. The results of each simulated marketing message can be stored in the simulation profile, for instance in a results.csv file.

Optionally, the simulated reaction sets can be generated by concurrently generating a plurality of simulated reaction set. For example, the run simulation script can specify a number of concurrent HCP-marketing message simulations to perform concurrently. This allows the server 106 to process multiple LLM interactions simultaneously, enhancing performance and reducing simulation time. The number of concurrent HCP-marketing message simulations to perform concurrently may be limited based on network or access constraints and/or to minimize or avoid corruption in the generation of the simulated reaction sets.

Following completion of the simulation, a validation phase 534 may be conducted in order to validate the data that is generated by the simulation. The validation phase can evaluate the stored results of each simulated marketing message to ensure completeness and correctness of the simulation results. For instance, the validation phase can validate that each simulation result includes an HCP reaction that is defined quantitatively. Optionally, the validation phase can validate that each simulation result includes an HCP reaction rationale.

The validation phase can also ensure that the simulation result data has been stored consistently. For instance, the simulation may be implemented using multiple concurrent simulations performed by the LLM system. The validation phase can validate that the results database has not been corrupted as concurrent simulation results are stored.

Typically, the validation phase occurs following completion of the simulation. Optionally, a validation phase may occur at an intermediate phase of the simulation. This may desirable, for instance, where a simulation has been paused mid-run (e.g. due to the length of the simulation). This can ensure that the simulation is proceeding correctly to minimize or avoid data corruption and/or loss and in turn minimize or avoid unnecessary resource utilization.

The validation phase can be performed by validating the simulated reaction set using a predefined validation script. A user can input the predefined validation script into the user device 102 in order to validate the results of the simulation.

Optionally, the validation phase 534 may include normalizing the prescription output 526 recorded from the simulated patient interactions, as well as validating the simulated prescription data against real world data of the particular HCPs, particular patients, or against statistical averages of the HCP prescribing behaviors or patient behaviors.

Optionally, following the completion of the simulation (and optional validation phase), the simulation results can be analyzed. Analysis of the simulation results can be defined to identify patterns or statistical assessments of the simulated marketing message reactions.

Optionally, a visualization of the output for a given marketing message can be generated. The visualization can be generated for a given marketing message by generating a visual representation of the simulated reaction set generated for that marketing message. The visualization may then be displayed through a display device of the user device. The visualization may provide a visual representation (e.g., heat maps, bar graphs, word clouds etc.) of analysis of the simulated reaction set generated for a given marketing message. Optionally, the visualization may provide a visual representation of the simulated reaction set for a plurality of marketing messages from the simulation profile. This may simplify the comparison of the reactions to the marketing messages being tested.

Referring next to FIG. 6, there is shown an example data frame block diagram 600 illustrating an example of data flow during an example method of simulating a marketing reaction.

The data frame may be created in several broad steps including an initial data population 620, a simulation data population 622, a response data population 624 and a data storage step 626.

In the initial data step 620, one or more HCP profiles 602 may be constructed using the LLM system and stored in the data frame. The HCP Profiles 602 may be constructed using the LLM system, and these profiles incorporate real-world data elements such as specialty, location, name, and more. The simulators may fine-tune this data to match the specific needs of the simulation process. For example, as described at 506 (see FIG. 5).

Optionally, one or more patient profiles 604 may be constructed at step 620. The patient profiles 604 may be constructed using a combination of LLM-system-based generation and real-world data inputs. The simulator may use gender and age demographics from census data to create realistic fictional patients for the simulation, for example, as described at 508 (see FIG. 5).

The data frame may have one or more columns 606 associated with it. These may include one or more of:
primary_key (int): A unique identifier assigned to each event in the DataFrame.
run_number (int): Incremental identifier for a full simulation run on a single HCP
hcp_id (int): The unique identification number of the healthcare professional involved in the event.
patient_id (int): Unique identification number of the patient involved in the event.
message_id (int): Distinguishes the specific marketing message used in the marketing event.
message_channel (string): Indicates the medium, or ‘channel’, through which the marketing message was delivered.
resulting_rx_decision (string-JSON formatted): Initially an empty string, this field will be updated during the simulation process to record Rx responses from simulated HCP interactions with patients, formatted as A JSON string.
reaction_to_message (string): Initially empty and updated during simulation to capture the simulated reaction of the HCP after encountering a marketing message.

Finally, initial event sequence data 608 may be stored in the data frame. This data may specify the sequence of simulated events. It can be random, handcrafted (based on specific hypotheses or real-life campaigns), or according to a defined model, such as a marketing mix model.

The simulation data population 622 includes collecting interactions data 610 from the simulation profile, which can include combined HCP profile data, patient profile data, and prompt instructions. This may be sent to the LLM system and a response may be received and stored 614 in the simulation profile. The interactions data 610 may combine HCP profiles, patient profiles, and the predefined instructions for LLM. This suite of data may be fed into the LLM system, driving individual interactions within the simulation.

The simulation data population 622 also includes pre-populations of the data frame with the initial event sequence data 608. This may also include pre-population with initial sequence derived from the sequence data, this may provide a separate quantitative basis for the simulation by the LLM system.

The response data 614 includes the response from the LLM system. A response from the LLM system may include variables recording the resulting prescription decision (resulting_rx_decision) and the reaction to the marketing message (reaction_to_message).

Finally, the data storage step 626 may log the API calls 616 from the LLM system. This may be used after the fact in order to diagnose or debug simulation results and any issues identified during the validation period of the marketing message simulation system.

The event sequence 612 and the api call logs 616 may be stored in CSV files, or in the simulation profile database for future analysis.

The present invention has been described here by way of example only. Various modification and variations may be made to these examples without departing from the scope of the disclosed invention, which is limited only by the appended claims.

All publications, patents and patent applications are herein incorporated by reference in their entirety to the same extent as if each individual publication, patent or patent application was specifically and individually indicated' to be incorporated by reference in its entirety.

1. A computer-implemented method for evaluating the effectiveness of a marketing message by simulating a reaction to the marketing message, comprising:
receiving, by a processor, a marketing message request comprising one or more marketing messages;
generating, by the processor, a simulation profile based on a plurality of healthcare professional profiles and the marketing message request;
generating, at the processor, a simulated reaction to the one or more marketing messages for a candidate healthcare professional profile of the plurality of healthcare professional profiles in the simulation profile, the simulated reaction generated by:
sending, to a large language model system, a first prompt comprising the candidate healthcare professional profile and the one or more marketing messages; and
receiving, from the large language model system, a first response based on the first prompt comprising the simulated reaction to the one or more marketing messages from the candidate healthcare professional profile,
updating the simulation profile with the simulated reaction; and
outputting, at a display device in communication with the processor, the reaction to the marketing message based on the simulation profile.

2. The method of claim 1, further comprising:
generating, at the processor, a data frame, and
storing the data frame in the simulation profile.

3. The method of claim 1, wherein the plurality of healthcare professional profiles comprises a plurality of simulated healthcare professional profiles, wherein each simulated healthcare professional profile is generated by a large language model in response to a profile creation prompt that specifies target profile characteristics, wherein the target profile characteristics comprise a plurality of profile attributes and a plurality of attribute distribution sets, wherein each attribute distribution set corresponds to a particular profile attribute in the plurality of profile attributes and each attribute distribution set defines a statistical distribution of attribute values that can be defined for the corresponding profile attribute for the simulated healthcare professional profiles.

4. The method of claim 3, further comprising generating the plurality of simulated healthcare professional profiles by transmitting the profile creation prompt to the large language model and receiving the plurality of simulated healthcare professional profiles as an output from the large language model.

5. The method of claim 4, further comprising validating the simulated healthcare professional profiles in the plurality of simulated healthcare professional profiles by automatically comparing the profile attributes of each simulated healthcare professional profile received from the large language model to the plurality of attributes distribution sets.

6. The method of claim 5, further comprising identifying at least one invalid simulated healthcare professional profile and omitting each simulated healthcare professional profile in the at least one invalid simulated healthcare professional profile from the plurality of healthcare professional profiles included in the simulation profile.

7. The method of claim 1, further comprising:
generating, at the processor, a simulated reaction set for each marketing message by for each healthcare professional profile in the plurality of simulated healthcare professional profiles, generating a simulated reaction to that marketing message.

8. The method of claim 7, further comprising:
generating a visualization output for a given marketing message by, for that given marketing message, generating a visual representation of the simulated reaction set; and
displaying the visualization output on a display device.

9. The method of claim 7, further comprising validating the simulated reaction set using a predefined validation script.

10. The method of claim 1, wherein generating the simulation profile comprises:
sending, to the large language model system, at least one existing component of the candidate healthcare professional profile;
receiving, from the large language model system, a simulated component of the candidate healthcare professional profile; and
updating the candidate healthcare professional profile with the simulated component prior to generating the simulated reaction for the candidate healthcare professional profile.

11. The method of claim 1 wherein the simulated reaction comprises a reaction indictor corresponding to one of a simulated ignore, an unchanged reaction, or a convinced reaction.

12. The method of claim 12 wherein the simulated reaction comprises a simulated rationale associated with the simulated reaction, wherein the simulated rationale provides a qualitative description generated by the large language model of a rationale for the simulated reaction generated by the candidate healthcare professional profile.

13. A computer-implemented system for evaluating the effectiveness of a marketing message by simulating a reaction to the marketing message, the system comprising:
a non-transitory storage memory storing a plurality of healthcare professional profiles, comprising:
a processor in communication with the memory, the processor configured to:
receive, a marketing message request comprising one or more marketing messages;
generate a simulation profile based on the plurality of healthcare professional profiles and the marketing message request;
generate a simulated reaction to the one or more marketing messages for a candidate healthcare professional profile of the plurality of healthcare professional profiles in the simulation profile, the simulated reaction generated by:
sending, to a large language model system, a first prompt comprising the candidate healthcare professional profile and the one or more marketing messages; and
receiving, from the large language model system, a first response based on the first prompt comprising the simulated reaction to the one or more marketing messages from the candidate healthcare professional profile,
update the simulation profile with the simulated reaction; and
output, to a display device in communication with the processor, the reaction to the marketing message based on the simulation profile.

14. The system of claim 13, wherein the processor is further configured to generate a data frame, and store the data frame in the simulation profile.

15. The system of claim 13, wherein the plurality of healthcare professional profiles comprises a plurality of simulated healthcare professional profiles, wherein each simulated healthcare professional profile is generated by a large language model in response to a profile generation prompt that specifies target profile characteristics, wherein the target profile characteristics comprise a plurality of profile parameters and a plurality of parameter distribution sets, wherein each parameter distribution set corresponds to a particular profile parameter in the plurality of profile parameters and each parameter distribution set defines a statistical distribution of parameter values that can be defined for the corresponding profile parameter for the simulated healthcare professional profiles.

16. The system of claim 15, wherein the processor is further configured to generate the plurality of simulated healthcare professional profiles by transmitting the profile generation prompt to the large language model and receiving the plurality of simulated healthcare professional profiles as an output from the large language model.

17. The system of claim 16, wherein the processor is further configured to validate the simulated healthcare professional profiles in the plurality of simulated healthcare professional profiles by automatically comparing the profile parameters of each simulated healthcare professional profile received from the large language model to the plurality of parameter distribution sets.

18. The system of claim 17, wherein the processor is further configured to identify at least one invalid simulated healthcare professional profile and omit each simulated healthcare professional profile in the at least one invalid simulated healthcare professional profile from the plurality of healthcare professional profiles included in the simulation profile.

19. The system of claim 13, wherein the processor is further configured to:
generate a simulated reaction set for each marketing message by for each healthcare professional profile in the plurality of simulated healthcare professional profiles, generating a simulated reaction to that marketing message.

20. The system of claim 19, wherein the processor is further configured to:
generate a visualization output for a given marketing message by, for that given marketing message, generating a visual representation of the simulated reaction set; and
display the visualization output on the display device.

21. The system of claim 19, wherein the processor is further configured to validate the simulated reaction set using a predefined validation script.

22. The system of claim 18, wherein the processor is configured to generate the simulation profile by:
sending to the large language model system the candidate healthcare professional profile;
receiving from the large language model system, a simulated component of the candidate healthcare professional profile; and
updating the candidate healthcare professional profile with the simulated component.

23. The system of claim 13 wherein the simulated reaction comprises one of a simulated ignore, an unchanged reaction, or a convinced reaction.

24. The system of claim 23 wherein the simulated reaction comprises a simulated rationale associated with the simulated reaction.
